(19) United States
(12) Patent Application Publication
(10) Pub. No.: US 2008/0055358 A1
(43) Pub. Date: Mar. 6, 2008

(54) IMAGE FORMING APPARATUS AND METHOD OF CONTROLLING DRIVING OF IMAGE FORMING APPARATUS

(75) Inventors: Youn-gun Jung, Suwon-si (KR); Jin-ho Park, Yongin-si (KR); Gun Heo, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/682,560

(22) Filed: Mar. 6, 2007

(30) Foreign Application Priority Data
Sep. 1, 2006 (KR) 2006-84415

(51) Int. Cl. B41J 2/165

(52) U.S. Cl. 347/32

(57) ABSTRACT

An image forming apparatus and a method of controlling a driving of the image forming apparatus. The image forming apparatus includes an ink cartridge including a plurality of printheads which form an image on a printing material, a capping unit movable between a first position to cover the printheads and a second position which is located away from the printheads, a wiping unit which moves in a direction of printing material conveyance, and wipes the printheads, and a cleaning member provided in the capping unit to clean an ink of the wiping unit.

### CROSS-REFERENCE TO RELATED APPLICATIONS

This application claims priority under 35 U.S.C. § 119(a) of Korean Patent Application No. 2006-84415 filed on Sep. 1, 2006, in the Korean Intellectual Property Office, the entire disclosure of which is hereby incorporated by reference.

### BACKGROUND OF THE INVENTION

1. Field of the Invention

The present general inventive concept relates to an image forming apparatus and a method of controlling driving of the image forming apparatus. More particularly, the present general inventive concept relates to an image forming apparatus which prints an image in a page unit, using a plurality of printheads arranged in a widthwise direction of a printing medium, and a method of controlling the driving of the image forming apparatus.

2. Description of the Related Art

An image forming apparatus such as an inkjet printer forms an image on a surface of paper, fabric, or any other printing medium, by ejecting ink droplets onto desired positions of the printing medium. Because inkjet printers generally employ an ink cartridge which moves linearly back-and-forth to print out a desired image, the inkjet printers inherently have a drawback of not printing very fast.

Recently, inkjet printers have employed an ink cartridge having a plurality of printheads along a widthwise direction of the printing medium, in which an image is formed without requiring the back-and-forth movement of the ink cartridge. These types of inkjet printers are called array printhead type inkjet printers.

The array printhead type ink cartridge generally includes a plurality of ink tanks holding printing ink, a plurality of negative pressure adjusting parts connected to the plurality of ink tanks, a plurality of printheads arranged in the widthwise direction of the printing medium in a predetermined pattern, and an ink channel unit to supply ink of the ink tanks to the printheads.

The ink tanks are mounted to a frame, and each holds color ink such as yellow (Y), magenta (M), cyan (C), or black (B) ink.

The negative pressure adjusting part is mounted to a lower portion of the frame, and in fluid communication with the ink tanks. The negative pressure adjusting part generates negative pressure to prevent ink leakage.

The ink channel unit is connected with the negative pressure adjusting part, and operates to supply the ink received through the negative pressure adjusting part into a plurality of printheads, respectively.

The printheads are arranged in a predetermined pattern and attached to a front side of the ink channel unit. Each of the printheads is provided with a plurality of nozzles to fire ink, and through the nozzles, the ink received through the ink channel unit is fired onto the printing medium. The nozzles are categorized according to colors, and generally, nozzles for different colors of ink are arranged in the direction of the printing medium conveyance.

The array printhead type image forming apparatus constructed as explained above provides advantages such as improvement of printing speed and simplified structure. However, the following problems are also experienced.

In order to wipe the printheads arranged in the widthwise direction of the printing medium, a blade has to be moved either in the widthwise direction or the conveyance direction of the printing medium. If the blade is moved in the widthwise direction of the printing medium, the blade has to cover relatively wide area of the printheads and is easily contaminated. Accordingly, efficient wiping is difficult, and wiping operation is also retarded.

In order to prevent the above problems, an elongated blade in the widthwise direction of the printing medium is moved in the direction of printing medium conveyance, and can wipe the plurality of printheads simultaneously.

However, because the elongated blade is contaminated with ink, the blade can contaminate the printheads in subsequent wiping operations. A scraper may be provided to avoid such problem, but the scraper is limited due to a length of the blade, which is as long as the width of the printing medium.

### SUMMARY OF THE INVENTION

The present general inventive concept provides an image forming apparatus which has a wiper scarping operation, and a method of controlling the driving of the image forming apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an image forming apparatus include an ink cartridge including a plurality of printheads which form an image on a printing material, a capping unit movable between a first position to cover the printheads and a second position which is located away from the printheads, a wiping unit which moves in a direction of print material conveyance, and wipes the printheads, and a cleaning member provided in the capping unit to clean ink from the wiping unit.

The foregoing and/or other aspects and utilities of the present general inventive concept may also be achieved by providing a method of controlling driving of an image forming apparatus, including moving a blade to wipe printheads of an ink cartridge, capping with a cap member the printheads if the wiping with the blade is completed, and moving the blade to a lower side of the cap member to clean an ink of the blade.

The foregoing and/or other aspects and utilities of the present general inventive concept may also be achieved by providing an image forming apparatus that forms images on print material using an ink cartridge including a plurality of printheads each having nozzles which eject ink to form an image on a printing material, the ink cartridge having a width greater than a width of the printing material in a widthwise direction, the image forming apparatus including a wiping unit which moves in a direction of the print material conveyance to wipe the nozzles of the plurality of printheads, the wiping unit having a width greater than the width of the ink cartridge in the widthwise direction, and a cleaning unit to clean an ink of the wiping unit, the cleaning unit having a width greater than the width of the wiping unit in the widthwise direction.

The foregoing and/or other aspects and utilities of the present general inventive concept may also be achieved by providing an image forming apparatus including a plurality of printheads to form an image on a printing material using ink, a capping unit movable between a first position to cover the printheads and a second position which is located away from the printheads, a wiping unit to wipe ink from the printheads, a cleaning unit disposed below the capping unit to clean the ink from the wiping unit, a driving unit to drive the capping unit, the wiping unit, and the cleaning unit, and a control unit to control the driving unit.

The foregoing and/or other aspects and utilities of the present general inventive concept may also be achieved by providing a method of maintaining a plurality of printheads, the method including driving a wiping unit from a home position to wipe ink residue from the plurality of printheads, driving a platen member from an initial position away from the plurality of printheads to a printing position underneath the plurality of printheads, forming an image on the printing material with the plurality of printheads using ink, driving the platen from the printing position back to the initial position, driving the wiping unit back to the home position, capping the printheads with the capping unit by driving the capping unit from the waste ink removing position to the capping position, cleaning the ink residue from the wiping unit with a cleaning member disposed in the capping unit, and driving the capping unit from the capping position to the waste ink removing position away from the plurality of printhead.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1A is a schematic view illustrating an image forming apparatus according to an exemplary embodiment of the present general inventive concept;

FIG. 1B is a bottom view illustrating an ink cartridge of FIG. 1A;

FIG. 1C is a perspective view illustrating a capping unit of FIG. 1A;

FIG. 2A is a view illustrating the capping unit of FIG. 1A in a lowered position;

FIG. 2B is a schematic view illustrating a structure of a wiping unit of FIG. 1A;

FIG. 2C is a perspective view illustrating a guide member of FIG. 1A;

FIGS. 2D and 2E illustrate sectional views taken on line I-I of FIG. 2C;

FIG. 2F is a bottom view illustrating a cleaning member of FIG. 1C;

FIG. 2G illustrates a sectional view taken on line II-II of FIG. 2F;

FIG. 3A is a view illustrating a wiping operation after the capping unit is lowered as illustrated in FIG. 2A;

FIG. 3B is a view illustrating a state of the wiping unit during a printing operation;

FIG. 4A is a view illustrating an operation of returning the wiping unit for a predetermined distance;

FIG. 4B is a view illustrating an operation of lifting the capping unit from the position of FIG. 4A to a first position;

FIG. 5A is a view illustrating a scraping operation of a blade;

FIG. 5B is a view illustrating a completion state of the scraping operation; and

FIG. 5C is a view illustrating a state in which the wiping unit is returned to an initial position after having completed the scraping operation.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

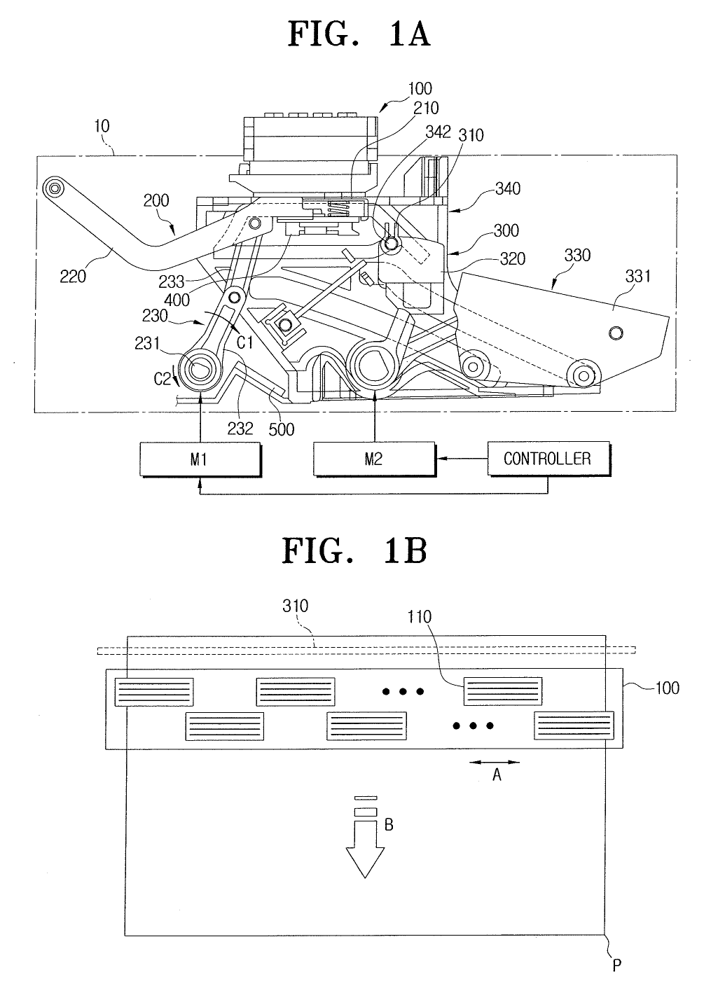

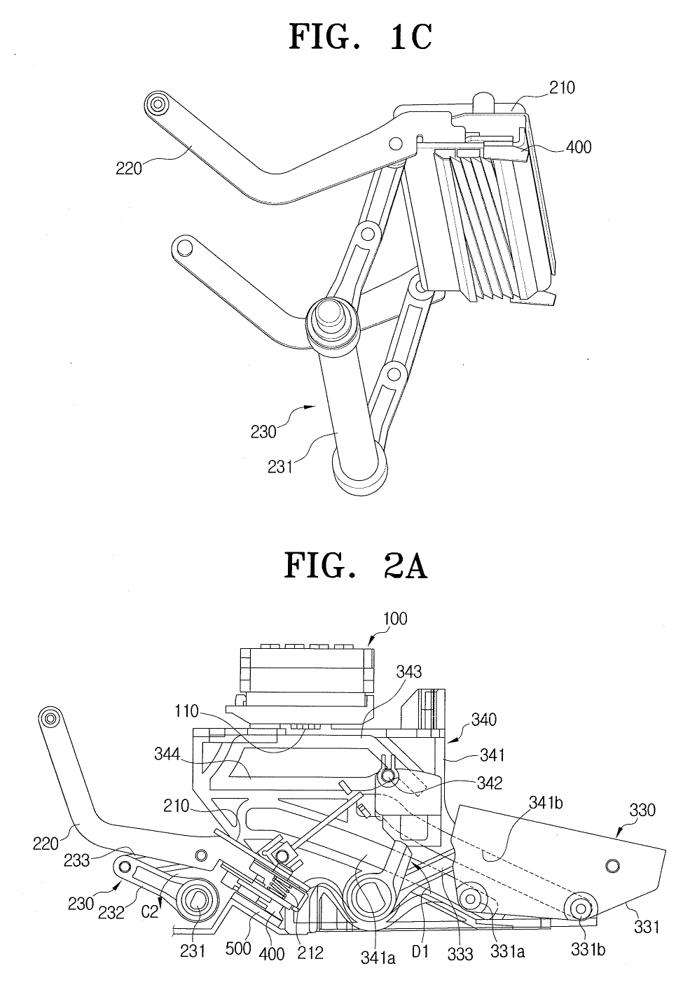

FIG. 1A illustrates the schematic structure of an image forming apparatus according to an exemplary embodiment of the present general inventive concept.

Referring to FIG. 1A, the image forming apparatus may include an ink cartridge 100, a capping unit 200, a wiping unit 300 and a cleaning member 400.

The ink cartridge 100 may be incorporated into an inkjet printer, and as illustrated in FIG. 1B, may have a printhead arrangement in which a plurality of printheads 110 are arranged in a widthwise direction (A) of a paper sheet, or any other printing material (P). The assignee of this application has disclosed a representative example of such an ink cartridge 100 in Korean Patent Application No. 10-2006-0068731, and therefore, the detailed explanation thereof will be omitted for the sake of brevity. In FIG. 1B, a reference character (B) refers to a direction of conveying printing material (P), and reference numeral 310 refers to a blade which wipes the printheads 110.

Referring to FIGS. 1A and 1C, the capping unit 200 may include a cap member 210 which covers the printheads 110, a supporting lever 220 and a link member 230.

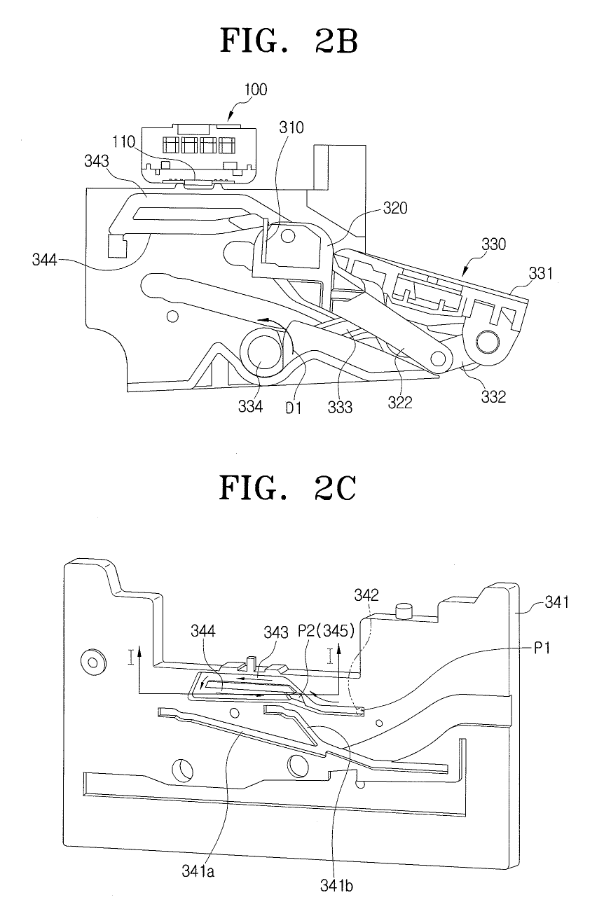

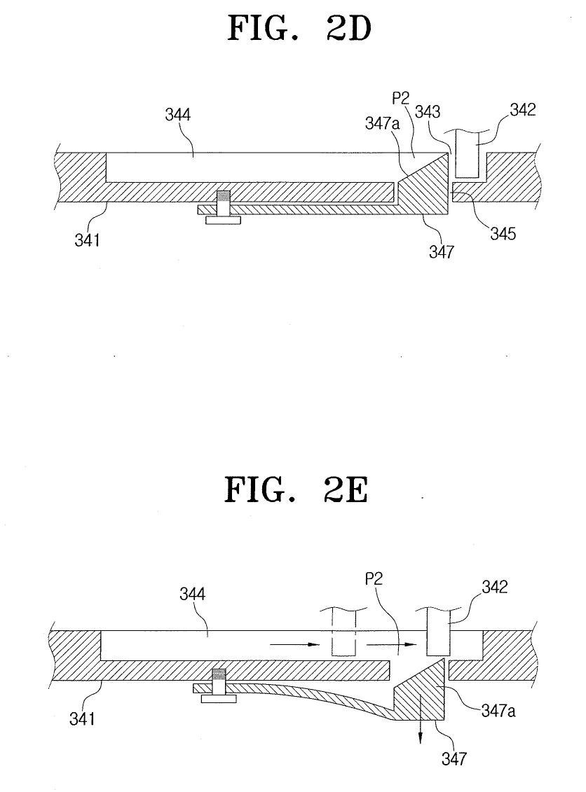

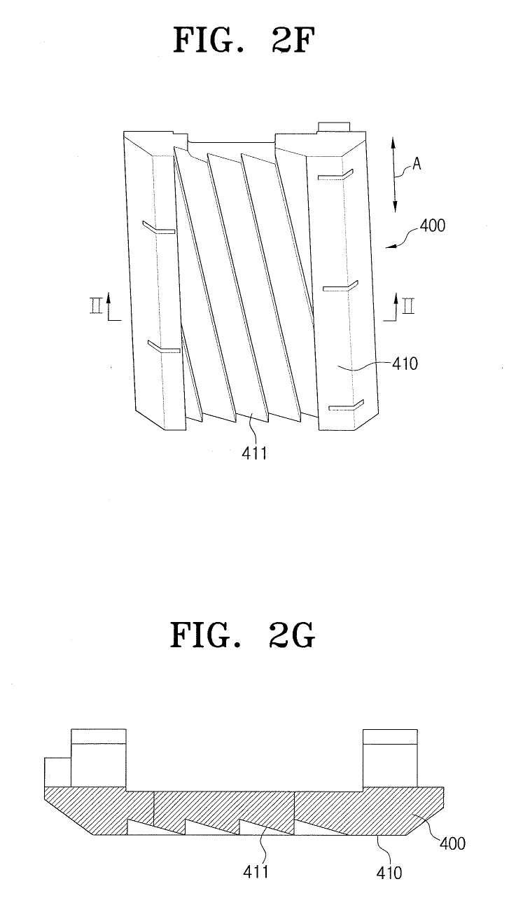

The cap member 210 is movable between a first position to cover the printheads 110 as illustrated in FIG. 1A, and a second position in which the cap member 210 is located away from the printheads 110, as illustrated in FIG. 2A. The cap member 210 may be supported by a spring 212 to be elastically movable on the supporting lever 220.

One end of the supporting lever 220 is pivotally connected to a frame 10 of the image forming apparatus, and another end supports the cap member 210. The supporting lever 220 supports the cap member 210 so that the cap member 210 can be moved between the first and second positions.

The link member 230 receives a driving force to drive the capping unit 200 from a first driving motor M1 and pivots the supporting lever 220. The link member 230 may include an axle member 231 connected to the frame 10, and first and second links 232, 233 connecting the axle member 231 and the another end of the supporting lever 220. One end of the first link 232 is connected with the axle member 231 so that the first link 232 is rotated together with the axle member 231, and another end of the first link 232 is pivotally connected to the second link 233. One end of the second link 233 is pivotally connected with the first link 232, and another end of the second link 233 is pivotally connected with the other end of the supporting lever 220. Accordingly, if the axle member 231 is pivoted in a direction C1, as illustrated in FIG. 1A, the first and the second links 232, 233 are pivoted apart from each other, accordingly lifting the supporting lever 220, and subsequently moving the cap member 210 to the first position. If the axle member 231 is rotated in a direction C2 from the position of FIG. 1A, as illustrated in FIG. 2A, the links 232, 233 become overlapped, accordingly lowering the supporting lever 220 and subsequently moving the cap member 210 to the second position.

The wiping unit 300 operates to remove ink from nozzle surfaces of the printheads 110, and may include at least one blade 310, a housing 320 which supports the blade 310, a driving unit 330 which drives the housing 320, and a guide unit 340 which guides the movement of the housing 320.

As explained above with reference to FIG. 1B, the blade 310 is elongated in the widthwise direction (A) of the printing material (P) and extends to be longer than the ink cartridge 100. The blade 310 is moved in the conveyance direction (B) of the printing material (P), wiping the nozzle surfaces of the printheads 110. Accordingly, ink is removed from the nozzle surfaces. A pair of blades 310 may be arranged in parallel in the widthwise direction (A) of the printing material (P), and supported on the housing 320.

With reference to FIGS. 1A, 2A, and 2B, in the housing 320, the blade 310 may be supported on an upper portion of the housing 320, and a connection unit 322 may be provided in a lower portion of the housing 320 to connect with a platen member 331 which will be explained below. The connection unit 322 and the platen member 331 are connected with each other via a connection member 332 to operate in association with each other, which will be explained below.

The driving unit 330 may include the platen member 331 which moves to a lower portion of the printheads 110 in a printing operation, and moves away from the lower portion of the printheads 110 in a capping operation, the connection member 332 being connected with the connection unit 322 of the housing 320 so as to move the housing 320 according to the movement of the platen member 331, and a pivot lever 333 which pivots by a driving force of a second driving motor (M2) to move the platen member 331.

Referring to FIG. 2A, the platen member 331 may include a pair of guide pins 331a, 331b which ride upwardly along first and second guide grooves 341a, 341b, and are placed in a lower portion of the ink cartridge 100 facing each other. Accordingly, printing is carried out as the printing material (P) is passed between the ink cartridge 100 and the platen member 331. One end of the connection member 332 is pivotally connected with the connection unit 322, and another end is pivotally connected with the platen member 331. According to the above structure, the housing 320, more specifically, the blade 310 is moved according to a movement of the platen member 331, and performs wiping, returning and scraping which will be explained below in detail.

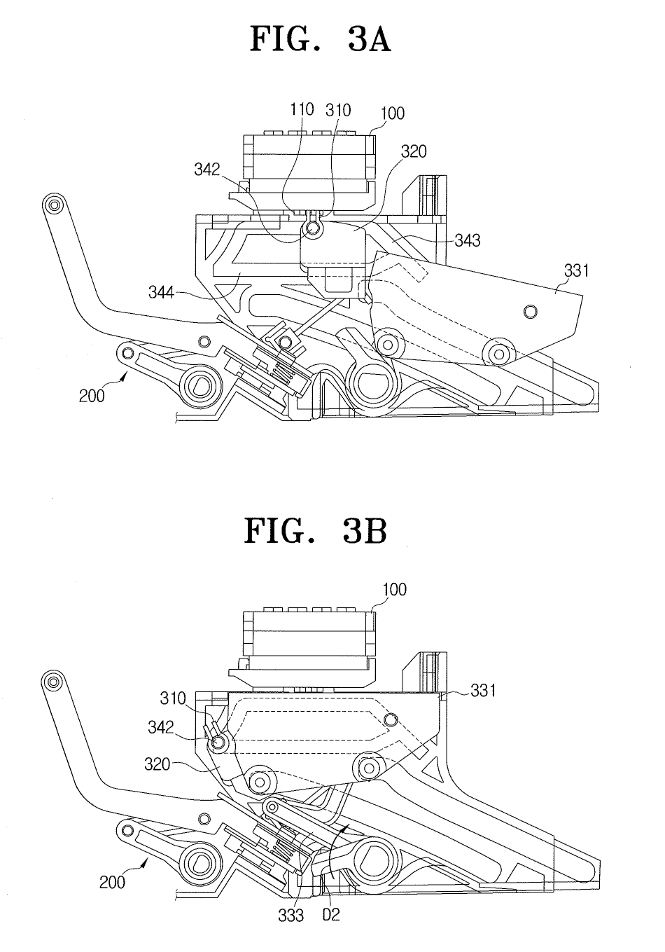

Referring to FIGS. 1A, 2A, 2B, and 2C, one end of the pivot lever 333 is pivotally connected with a frame 10 or a guide member 341, and another end is pivotally connected with the platen member either directly, or indirectly through a separate connection member. The axle member 334 engages with the one end of the pivot lever 333, and the axle member 334 rotates clockwise or counterclockwise if a driving force is transmitted from the second driving motor (M2). If the pivot lever 333 is rotated in a direction D1 in FIG. 2B, as illustrated in FIG. 3B, the platen member 331 is lifted to a lower side of the ink cartridge 100, and if the platen member 331 is rotated in a direction D2 in FIG. 3B, the platen member 331 is returned to an initial position.

Referring to FIGS. 2A and 2C, the guide unit 340 operates to guide the housing 320 along a predetermined path such that the nozzle surfaces of the printheads 110 can be wiped by the blade 310. The guide unit 340 may include the guide member 341, and a guide protrusion 342 formed on a sidewall of the housing 320. The guide member 341 is engaged with the frame 10, and includes a first path 343 and a second path 344 to guide the movement of the guide protrusion 342.

The first and second paths 343, 344 are formed in the guide member 341 in a closed loop pattern. The first path 343 guides the housing 320 such that the blade 310 is moved in contact with the printheads 110 from a home position to wipe the printheads 110. The second path 344 guides the housing 320 such that the blade 310 is moved along the first path 343, and then moved away from the printheads 110 to return to a home position (P1). The first and second paths 343, 344 are split from a junction (P2) which is located a predetermined distance away from the home position (P1), and there is a latch hole 345 formed in the junction (P2) through which a latch member 347 extends. The latch member 347 will be explained below. The guide protrusion 342 starts from the home position (P1), is guided along the first and second paths 343, 344 indicated by the arrows in FIG. 2C, and is returned to the home position (P1).

Referring to FIGS. 2D and 2E, the latch member 347 is additionally provided to prevent the guide protrusion 342, which starts from the home position (P1), from entering the second path 344 at the junction (P2), and to guide the guide protrusion 342 to the first path 343. One end of the latch member 347 is supported on the guide member 341, and another free end is a latch part 347a which is disposed in the latch hole 345. The latch member 347 has an inclined side such that the latch member 347 is not influenced by the guide protrusion 342 moving from the home position (P1) as illustrated in FIG. 2D, but is deformed by the guide protrusion 342 moving along the second path 344 to the junction P2. Accordingly, with assistance by the latch member 347, the guide protrusion 342 is guided from the home position P1, rides along the first and second paths 343, 344 and is returned to the home position (P1).

The cleaning member 400 is provided to the capping unit 200 to clean waste ink from the wiping unit 300, that is, from the blade 310. With reference to FIGS. 1A and 1C, the cleaning member 400 is formed at a lower side of the cap member 210. Of course, the cleaning member 400 may be fixed to the supporting lever 220. The cleaning member 400 is formed to have a position and posture such that the blade 310 is moved along the second path 344 in a direction opposite to a direction of contact with the cleaning member during a scraping operation, when the capping unit 200 is in a first position. The cleaning member 400 has a longer length than the blade 310, and has a wider cleaning surface 410 than the blade 310. More specifically, with reference to FIGS. 2F and 2G, the cleaning surface 410 of the cleaning member 400 may include a plurality of inclined surfaces 411 in an advancing direction of the blade 310. The inclined surfaces 411 are in parallel relation with each other, and at a predetermined angle with respect to the widthwise direction (A) of the printing material (P). Due to the inclined surfaces 411 with respect to the widthwise direction (A), a load caused by friction with the blade 310 can be reduced when the blade 310 is moved in a cleaning operation. The cleaning, and more particularly the scraping of the blade 310 by the cleaning member 400 will be explained in greater detail below.

Referring back to FIGS. 1A and 2A, a waste ink receiving member 500 may be additionally provided to receive and store the waste ink of the cleaning member 400. The waste ink receiving member 500 may be formed on the frame 10 or the guide member 341 to contact with the cleaning surface 410 of the cleaning member 400 when the capping unit 200 is moved to the second position away from the printheads 110. The waste ink receiving member 500 may include felt or a sponge.

The method of controlling the driving of the image forming apparatus having a construction as explained above in accordance with the exemplary embodiments of the present general inventive concept will be explained below.

FIG. 1A illustrates a capping state, that is a standby state in which the printheads 110 are covered and protected by the cap member 210. In this state, a controller 600 drives the first driving motor (M1) to lower the capping unit 200. Accordingly, as illustrated in FIG. 2A, the cap member 210 is moved away from the ink cartridge 100 and to the second position. The controller 600 drives the second driving motor (M2) to pivot the pivot lever 333 in the direction D1. Accordingly, as illustrated in FIG. 3A, the platen member 331 is lifted toward the lower side of the ink cartridge 100, and the housing 320 is moved to the lower side of the ink cartridge 100 according to the movement of the platen member 331. The guide protrusion 342 of the housing 320 is guided along the first path 343 and accordingly, the nozzle surfaces of the printheads 110 are wiped by the blade 310. After the wiping, the printheads 110 carry out a spitting operation in which the printheads 110 fire ink through the nozzles periodically, or as necessary, in accordance with a control signal. The spitting operation prevents clogging of the nozzles due to ink residue. Additionally, by firing the ink which is pushed into the nozzles by the blade 310 during the wiping operation, undesirable mixing of ink can be avoided. The spitting operation will not be explained in further detail below, as it does not characterize the features of the present general inventive concept.

After the nozzle surfaces of the printheads 110 are wiped by the blade 310 during the movement of the housing 320, as illustrated in FIG. 3B, the housing 320 is positioned at an end of the first path 343, that is, positioned at a beginning point of the second path 344 where the housing 320 is away from the ink cartridge 100 and the platen member 331 is positioned below the ink cartridge 100.

With reference to FIG. 3B, the printing material (P) is fed so that a printing operation is carried out.

Referring to FIGS. 1A, 2C, and 4A, after the printing operation, the controller 600 pivots the pivot lever 333 to a direction D2, and controls the driving such that the housing 320 is moved in the arrowed direction (refer to FIG. 2C) along the second path 344 and the guide protrusion 342 is placed in the junction (P2).

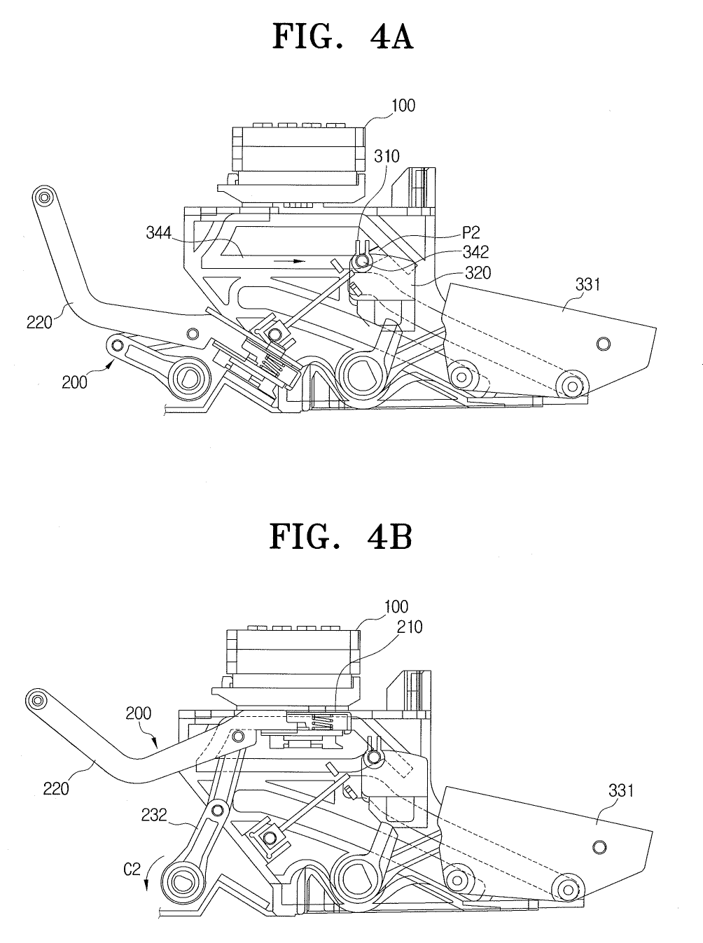

In FIG. 4A, the guide protrusion 342 is maintained in a standby state in a position as illustrated in FIG. 2E.

As the capping unit 200 is re-driven and lifted to a first position as illustrated in FIG. 4B, the cap member 210 is retained in the first position where the cap member 210 covers the printheads 110.

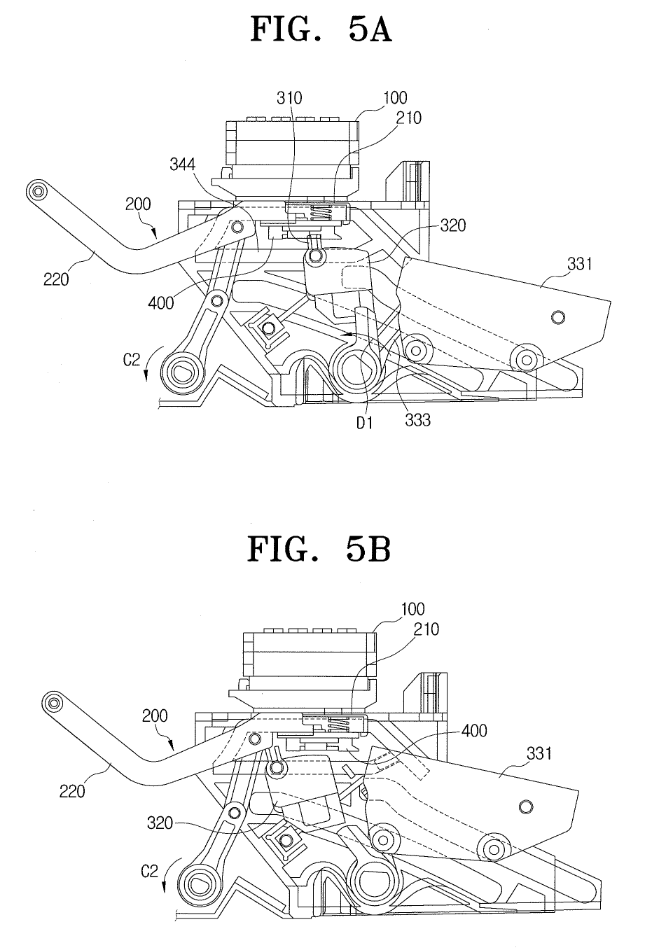

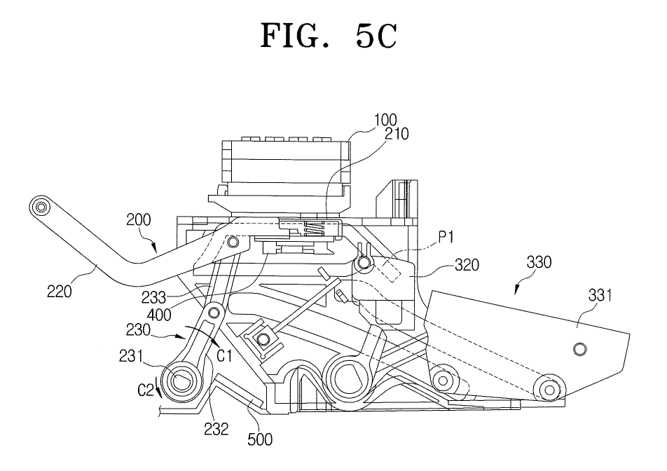

When the pivot lever 333 is pivoted in the direction D1, as illustrated in FIG. 5A, the housing 320 is moved back in the arrowed direction along the second path 344 (refer to FIG. 2C) such that the blade 310 is cleaned, that is, scraped by the cleaning member 400 which is provided at the lower part of the cap member 210. Accordingly, the waste ink is cleaned by the cleaning surface 410 of the cleaning member 400 and removed. When the blade 310 is completely passed along the cleaning member 400, and thus the scraping is completed, as illustrated in FIG. 5B, the wiping unit 300 is driven in an opposite direction. Accordingly, as illustrated in FIG. 5C, the housing 320 is moved along the second path 344 and returned to the home position (P1), and the platen member 331 is also returned to the initial position.

Meanwhile, as illustrated in FIGS. 2A and 2F, the waste ink on the cleaning surface 410 of the cleaning member 400 is transferred onto the ink receiving member 500 when the capping unit 200 is lowered to the second position and the cleaning member 400 is accordingly brought into contact with the ink receiving member 500. As a result, the cleaning surface 410 of the cleaning member 400 can be maintained in a dry state.

The above exemplary embodiments of the present general inventive concept incorporate two separate driving motors M1, M2 to drive the capping unit 200 and the wiping unit 300, respectively. However, this should not be construed as limiting. For example, a driving force of a single driving motor can be selectively transmitted to the capping unit 200 and the wiping unit 300 by use of a clutch. Additionally, the first driving motor M1 may also provide a driving force to convey the printing material (P).

As explained above, with an image forming apparatus and a driving controlling method thereof according to the exemplary embodiments of the present general inventive concept, a blade is scraped when wiping is completed. Accordingly, blade contamination, and subsequent contamination of printheads 110 can be prevented. As a result, print quality degradation can be prevented.

Additionally, because the blade can be cleaned by repeatedly moving a wiping unit, separate components other than a cleaning member are unnecessary, and a compact-sized image forming apparatus can be provided.

Furthermore, with use of an ink receiving member which removes waste ink on the cleaning member after the scraping of the blade, high cleaning efficiency of the blade can be provided.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an ink cartridge comprising a plurality of printheads which form an image on a printing material;
a capping unit movable between a first position to cover the printheads and a second position which is located away from the printheads;
a wiping unit which moves in a direction of print material conveyance, and wipes the printheads; and
a cleaning member provided in the capping unit, to clean an ink from the wiping unit.

2. The image forming apparatus of claim 1, wherein the capping unit comprises:
a cap member which covers the printheads;
a supporting lever having one end pivotally engaged with a frame and another end pivotally engaged with the cap member; and
a link member having one end engaged with the frame and another end pivotally engaged with the cap member, which moves the cap member between the first and second positions according to a direction of pivoting movement.

3. The image forming apparatus of claim 1, wherein the wiping unit comprises:
a blade formed in parallel relation to a widthwise direction of the printing material and wipes the printheads during movement;
a housing which supports the blade;
a driving unit which provides a driving force to move the housing; and
a guide unit which guides the housing in a predetermined path according to which the blade wipes a nozzle surface of the printheads.

4. The image forming apparatus of claim 3, wherein the guide unit comprises:
a guide member which provides a first path in which the blade is brought into contact with the printheads at a home position and wipes the printheads during movement, and a second path in which the blade, having traveled the first path, is spaced apart from the printheads and returned to the home position; and
a guide protrusion provided to one side of the housing and guided along the first and second paths.

5. The image forming apparatus of claim 4, wherein the guide unit further comprises:
a latch member which is provided to selectively block the first or the second path at a junction,
wherein the latch member guides the guide protrusion moving from the home position to enter the first path, and allows the guide protrusion, which has traveled the second path and is returning, to move to the home position.

6. The image forming apparatus of claim 3, wherein the driving unit comprises:
a platen member which is moved to a lower side of the printheads during printing operation, and moved away from the lower side of the printheads during a capping operation;
a connection member which connects the platen member and the housing such that the housing is moved in accordance with the movement of the platen member; and
a pivot lever, in which one end is pivotally engaged with the platen member and another end is pivotally engaged with the frame, such that the pivot lever moves the platen member during pivoting movement.

7. The image forming apparatus of claim 1, wherein the cleaning member is provided at a lower side of the capping unit.

8. The image forming apparatus of claim 7, wherein the cleaning member comprises:
a cleaning surface which comprises a plurality of inclined surfaces in the cleaning direction of the blade.

9. The image forming apparatus of claim 8, wherein the inclined surfaces are at a predetermined angle with respect to a widthwise direction of the printing material.

10. The image forming apparatus of claim 7, further comprising:
a waste ink receiving member which receives a waste ink from the cleaning member and stores the received waste ink.

11. The image forming apparatus of claim 10, wherein the receiving member is brought into contact with the cleaning member when the capping unit is moved to the second position.

12. The image forming apparatus of claim 11, wherein the receiving member comprises a felt.

13. A method of controlling driving of an image forming apparatus, comprising:
moving a blade to wipe printheads of an ink cartridge;
capping the printheads with a cap member if the wiping with the blade is completed; and
moving the blade to a lower side of the cap member to clean ink from the blade.

14. The method of claim 13, wherein the wiping comprises:
lifting the blade from a home position to be in contact with the printheads;
moving the blade in contact with the printheads in a first direction; and
lowering the blade away from the printheads.

15. The method of claim 14, wherein the capping comprises:
moving the lowered blade in a second direction so that the blade is returned to a proximity of the home position; and
lifting the cap member to an intimate contact with a lower portion of the printheads.

16. The method of claim 15, wherein the cleaning comprises:
moving the blade at the returned position in a the first direction where the blade is cleaned by the lower portion of the cap member; and
returning the blade, which has moved past the lower portion of the cap member, in the second direction so that the blade is returned to the home position.

17. The method of claim 16, wherein a cleaning member is provided at a lower side of the cap member to clean the blade.

18. The method of claim 13, further comprising removing the ink from the lower side of the cap member by cleaning the blade.

19. The method of claim 18, wherein the removing comprises lowering the cap member to contact with a receiving member which is capable of absorbing ink.

20. An image forming apparatus that forms images on print material using an ink cartridge having a plurality of printheads each having nozzles which eject ink to form an image on a print material, the ink cartridge having a width greater than a width of the printing material in a widthwise direction, the image forming apparatus comprising:
a wiping unit which moves in a direction of the print material conveyance to wipe the nozzles of the plurality of printheads, the wiping unit having a width greater than the width of the ink cartridge in the widthwise direction; and
a cleaning unit to clean an ink of the wiping unit, the cleaning unit having a width greater than the width of the wiping unit in the widthwise direction.

21. The image forming apparatus of claim 20, wherein the cleaning unit comprises:
a cleaning surface which comprises a plurality of inclined surfaces formed at a predetermined angle with respect to the widthwise direction of the printing material.

22. The image forming apparatus of claim 20, wherein the wiping unit comprises:
a blade member formed parallel to the widthwise direction of the printing material which wipes the nozzles of the printheads during movement.

23. The image forming apparatus of claim 22, wherein the blade member comprises a pair of blades formed parallel to the widthwise direction of the printing material.

24. An image forming apparatus comprising:
a plurality of printheads to form an image on a printing material using ink;
a capping unit movable between a first position to cover the printheads and a second position which is located away from the printheads;
a wiping unit to wipe ink from the printheads;
a cleaning unit disposed below the capping unit to clean the ink from the wiping unit;
a driving unit to drive the capping unit, the wiping unit, and the cleaning unit; and
a control unit to control the driving unit.

25. The image forming apparatus of claim 24, further comprising:
a frame; and
a supporting lever attached to the frame to support the capping unit and the cleaning unit.

26. The image forming apparatus of claim 25, wherein the driving unit is attached to the supporting lever and the wiping unit to drive the capping unit.

27. The image forming apparatus of claim 26, wherein the driving unit comprises:
a first driving member to drive the capping unit and the cleaning unit disposed on the supporting lever; and
a second driving member to drive the wiping unit.

28. The image forming apparatus of claim 27, wherein the first driving member comprises:
first and second link members attached to a first driving motor and the supporting lever,
wherein the cleaning unit and the capping unit disposed on the supporting lever are moved between the first and second positions by the driving unit.

29. The image forming apparatus of claim 28, wherein the second driving member comprises:
a pivot lever attached to a second driving motor;
at least one connection member associated with the pivot lever and a platen,
wherein the platen is moved by the second driving motor to a home position away from the printheads during a capping operation to a printing position near the printheads during a printing operation.

30. The image forming apparatus of claim 29, wherein the first and second driving motors are the same driving motor.

31. A method of forming maintaining a plurality of printheads, the method comprising:
driving a wiping unit from a home position to wipe ink residue from the plurality of printheads;
driving a platen member from an initial position away from the plurality of printheads to a printing position underneath the plurality of printheads;
forming an image on the printing material with the plurality of printheads using ink;
driving the platen from the printing position back to the initial position;
driving the wiping unit back to the home position;
capping the printheads with the capping unit by driving the capping unit from the waste ink removing position to the capping position;
cleaning the ink residue from the wiping unit with a cleaning member disposed in the capping unit; and
driving the capping unit from the capping position to the waste ink removing position away from the plurality of printheads.

32. The image forming method of claim 31, further comprising:
removing the ink residue from the cleaning member with a waste ink receiving member while the capping unit is in the waste ink removing position.
